(19) United States
(12) Patent Application Publication
(10) Pub. No.: US 2017/0264749 A1
(43) Pub. Date: Sep. 14, 2017

(54) CROWDSOURCING-MODE-BASED ANALYSIS METHOD FOR UTILIZATION OF WIRELESS NETWORK RESOURCES BY MOBILE Apps

(71) Applicant: NANJING HOWSO TECHNOLOGY CO., LTD, Jiangsu (CN)

(72) Inventors: Donghua WU, Jiangsu (CN); Ye OUYANG, Jiangsu (CN); Jibin WANG, Jiangsu (CN); Alexis HUET, Vitry-aux-Loges (FR)

(73) Assignee: NANJING HOWSO TECHNOLOGY CO., LTD, Jiangsu (CN)

(21) Appl. No.: 15/127,400

(22) PCT Filed: Apr. 8, 2016
(86) PCT No.: PCT/CN2016/078830

§ 371 Date: Sep. 19, 2016

(30) Foreign Application Priority Data
Oct. 19, 2015 (CN) 201510674309.3

(51) Int. Cl. H04M 15/00; H04L 12/26; H04W 24/08; H04L 12/24; H04W 72/04; H04W 4/00

(52) U.S. Cl. CPC H04M 15/58; H04W 72/048; H04W 4/003; H04W 24/08; H04L 41/142; H04L 43/04; H04L 41/16; H04L 41/145

(57) ABSTRACT

A crowdsourcing-mode-based analysis method for utilization of wireless network resources by mobile applications (Apps) includes the following steps. Behavior characteristic data of each type of mobile App is collected by using a data collection tool, which is installed on a mobile client and based on a crowdsourcing technology and an analysis algorithm located on a cloud server, and using a machine learning algorithm targeted to the behavior characteristic data. A three-stage two-layer associated mapping model is established among a characteristic behavior of the mobile application, wireless network traffic, and wireless network resources, and quantitatively analyzing, in a time dimension, how each mobile application service in a mobile communications network consumes wireless resources in a cell.

### BACKGROUND OF THE INVENTION

Field of the Invention

The present invention relates to an analysis method for utilization of wireless network resources by mobile applications (Apps), and in particular, to a crowdsourcing-mode-based analysis method for utilization of wireless network resources by mobile Apps.

Description of the Related Art

Intelligent terminals get people closer to each other, and since various mobile-network-oriented mobile application services, which are referred to as Apps for short, are available on intelligent terminals, the connection between people is enhanced by using rich service content provided by the Apps, such as live video, email push, and online chatting, on the intelligent terminals. However, the rapid growth of Apps and the dramatic increase in network traffic brought about large mobile network overheads. In 2013, a global mobile data flow grew by 81%, exceeding the growth in 2012 and reaching 15 GB per month. Apart from the data flow, online chatting programs such as WeChat and Twitter need to periodically send about 2400 heartbeat signals per hour to a server for receiving push messages, and these Apps will be downloaded for 480 billion times in 2015. These data and signal storms dramatically consume terminal resources, for example, power supply, CPU and bandwidth resources, and sometimes also cause interruption of some mobile services, which significantly lowers the level of quality of service of the mobile networks. Based on the aforementioned fact, mobile communications operators pay more attention on how intelligent terminal Apps use wireless network resources of cells of base stations, where control over the resources, improvement of quality of service, and pricing of resource usage are especially important.

Although the issue of analysis on network resource usage has become a common concern of all mobile operators, a general situation at present is that current researches mainly focus on the performance and optimization of an intelligent terminal itself, for example, analysis of how various mobile Apps running on the terminal use resources of the intelligent terminal, while there is no effective method with regard to how the applications on the terminal utilize and consume wireless network resources of a cell in an optimized manner. Current researches related to terminal resource management may be classified into two types: (1) analysis on usage of intelligent terminal resources by mobile Apps, where this work focuses on a terminal end, and analyzes usage of intelligent terminal resources with respect to the Apps on the terminal; and (2) network resource management and optimization, where this work analyzes an issue of how user activities and mobile modes influence allocation of mobile network resources. The existing solutions cannot be directly used to solve the foregoing problem, because they either only focus on analyzing the resource usage at the terminal end or only focus on analyzing the network resource usage without considering the effect of Apps on the terminal. Therefore, mobile communications operators are in urgent need of an effective method to establish a mapping and an association between characteristic behaviors of mobile Apps, network traffic, and network resources, especially a method that emphasizes network-end-based analysis on the specific usage of wireless network resources by mobile Apps which are borne over wireless networks, so as to implement proper configuration and optimized usage of wireless resources of the network end.

However, unlike internal physical resources of a smartphone (which are directly invoked by only functions of terminal Apps), the wireless network resources are not only directly affected by Apps running on the mobile terminal but also affected by various complex wireless network conditions, such as a flow and signal strength. In addition, it is difficult to distinguish resources used by one App from resources used by other Apps even if concentration is given to mobile Apps only, because a lot of mobile Apps coexist in mobile networks and have huge impact on the networks. Finally, each particular mobile App is naturally applicable to different times and regions having different network conditions. Therefore, behaviors, network characteristics, and resource usage of mobile Apps eventually change frequently. Such characteristics as ambiguity, complexity, and being dynamic of mobile Apps impose a challenge to network resource analysis, and also make it extremely difficult for mobile operators to quantify resource usage of mobile Apps or perform relative ranking and the like on the mobile Apps.

### SUMMARY OF THE INVENTION

The present invention solves the aforementioned problem in the prior art, that is, the present invention provides a crowdsourcing-mode-based analysis method for utilization of wireless network resources by mobile Apps, which analyzes network resource usage of each mobile App and uses the knowledge to provide mobile operators with decision-making suggestions, for example, suggestions on prediction, control, and quantified pricing on resources used by the App, so as to improve the utilization and efficiency of wireless network resources, and improve the level of quality of service.

To solve the foregoing technical problem, the present invention provides the following technical solution:

A crowdsourcing-mode-based analysis method for utilization of wireless network resources by mobile Apps is provided, including: collecting behavior indexes of a mobile App by using a crowdsourcing tool and an analysis algorithm that is located on a server, and performing data mining on the behavior indexes; and establishing a mapping model among behavior characteristic indexes of the mobile App, wireless network resources, and network traffic, and analyzing utilization of the network resources by the mobile App.

The mapping model is a two-layer causality mapping model, which is a quantifiable mapping established between the mobile App and the network traffic by selecting related indexes as feature items and as a regression basis.

The two-layer causality mapping model is specifically established in the following manner: designing a similarity matrix-assisted feature selection algorithm that is based on a random forest decision tree, selecting a mobile App performance characteristic index highly correlated to a network traffic index, developing a sliding-window-based locally weighted scatterplot smoothing algorithm, and establishing a two-layer mapping by performing regression on the selected indexes, where the two-layer mapping includes a mapping between the mobile App and the network traffic, and a mapping between the network traffic and the network resources, that is, a behavioral change of the mobile App can be used to build a model of a lower-layer network traffic change, and the network traffic is further used to build a model of the network resources.

It is assumed that the similarity matrix is P, and P is an n*n all-zero matrix; for a node of a tree, it is assumed that there are two indexes, which are recorded as fᵢ and fⱼ respectively, an item Pᵢⱼ in the matrix is modified to be a value obtained by adding Pᵢⱼ by 1: Pᵢⱼ=Pᵢⱼ+1, and this process is repeated until all decision trees are generated; a value of each item in the matrix is normalized or quantified, where each item represents a similarity of an index pair corresponding to the item.

The sliding-window-based locally weighted scatterplot smoothing algorithm is specifically established in the following manner: using selected indexes as feature items, distributing values of the feature items into corresponding window intervals, and dynamically adjusting window sizes according to distribution and local settings of windows.

After the windows are configured, a feature item with n points and K windows each having the same length (that is, L=n/k) is given, an initial window size is set to

$$\frac{n}{100} ,$$

and a scatterplot is drawn for all measured values sorted in ascending order; it is assumed that f(x), (x=1, . . . , n) represents a function of the scatterplot; first of all, a distribution density of each window is calculated from all function values within a range of the scatterplot in the formula below:

Fⱼ=∫_{f}_{^{−1}}_{(L*j)}^{f}^{^{−1}}^{(L*j+L)}f(x)dx,(j=0, . . . ,k−1)

then, F={F₀, . . . , Fₖ₋₁} is sorted in ascending order, assuming that B_{Fmin} represents a window corresponding to a minimum value in F, B_{Fmed} represents a window corresponding to a mean value in F, and B_{Fmax} represents a window corresponding to a maximum value in F; and the window sizes are dynamically calculated according to a sorting result in the formula below:

$${win}_{—} size = \{ \begin{matrix}\frac{0.5 ( 1 + 1 \text{/} i ) * B}{100} * N , ( B = 0 , … , i ) \\ \frac{1 + ( B - i )}{100} * N , ( B = i + 1 , i + 2 , … , k )\end{matrix}$$

after that, an LOESS regression algorithm is dynamically performed on selected feature items at two layers, and the mappings at the two layers are successfully obtained after the regression; behavior characteristic index information of the mobile App is used to build a model of the network traffic, and the network traffic is used to build a model of the network resources, that is, a model for cell-plane-based utilization of cell network resources by the mobile service App is built.

A beneficial effect of the present invention is that usage of network resources by each mobile App is analyzed, and the knowledge is used to provide mobile operators with decision-making suggestions, for example, suggestions on prediction, control and pricing of resources used by the App, so as to improve a resource allocation rate and the level of quality of service.

### BRIEF DESCRIPTION OF THE DRAWINGS

FIG. 1 is a principle diagram of the present invention; and

FIG. 2 is a model of an embodiment.

### DETAILED DESCRIPTION OF THE PREFERRED EMBODIMENTS

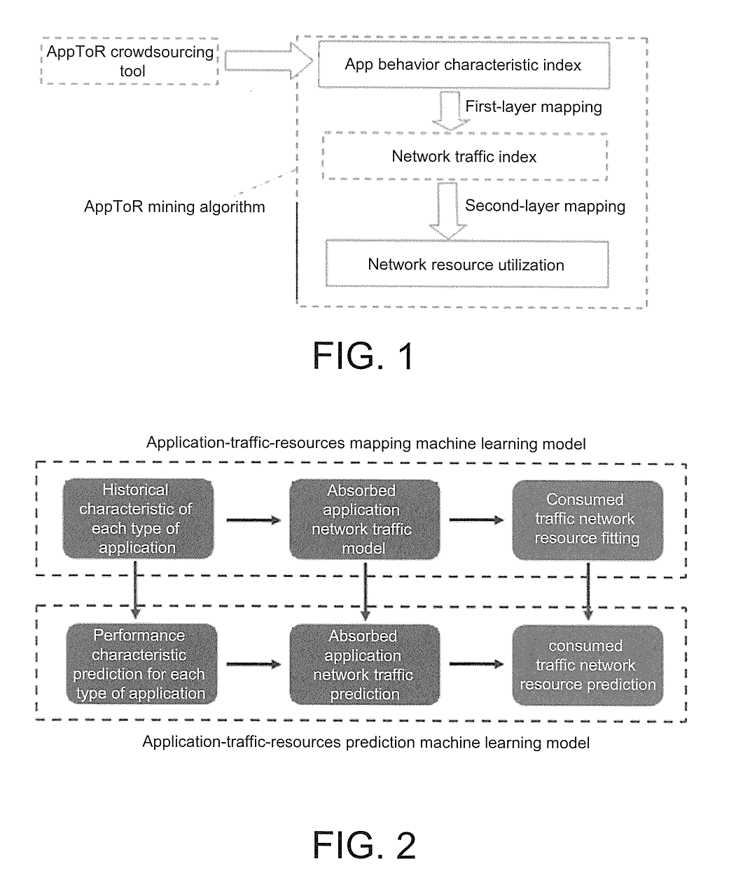

As shown in FIG. 1, disclosed in the present invention is a crowdsourcing-mode-based analysis method for utilization of wireless network resources by mobile Apps, including: collecting behavior indexes of an App by using a crowdsourcing tool and an analysis algorithm that is located on a server; performing data mining on the behavior indexes; establishing a two-layer causality mapping model (as shown in FIG. 2) among the behavior indexes of the App, wireless network resources, and network traffic; and analyzing utilization of the network resources by the mobile App.

The two-layer causality mapping model is specifically established in the following manner: designing a similarity matrix-assisted feature selection algorithm that is based on a random forest decision tree, selecting an App measurable index highly correlated to network traffic, developing a sliding-window-based locally weighted scatterplot smoothing algorithm, and establishing, by performing regression on the selected indexes, a mapping between the mobile App and the network traffic; a behavioral change of the mobile App can be used to build a model for a lower-layer network traffic change.

The similarity matrix-assisted feature selection (PMFS) algorithm is designed to select related characteristic indexes for establishing the two-layer mapping model, that is, importance of each index is scored according to a similar distance between indexes by using a random forest decision tree.

After the data collection, each index in each recording is marked according to related 3GPP technology standards (such as 3GPP TS 36.104) and measured values of the indexes. Supervised learning including decision trees and random forest classifier is adopted for data classification. When a tree is built, a two-dimensional similarity matrix is designed, where there is a similar distance between indexes recorded in each item. The designed similarity matrix is used to measure a similarity between clusters, and the knowledge is used to score the importance of each index when data is classified into different classes. Only indexes with high scores are selected as characteristic indexes, because these characteristic indexes are considered to be related to data changes.

More specifically, in the process of generating a random forest decision tree, the similarity matrix is improved constantly. If a training data set containing n indexes is given, initially, a similarity matrix P is an n*n all-zero matrix. When the tree is generated, each node in the tree is studied as follows:

For a node of a tree, it is assumed that there are two indexes, which are recorded as fᵢ and fⱼ respectively, a value of an item Pᵢⱼ in the matrix is modified to be a value obtained by adding Pᵢⱼ by 1 (that is, Pᵢⱼ=Pᵢⱼ+1). This process is repeated until all decision trees are generated. Then, a value of each item in the matrix is normalized (or quantified), where each item represents a similarity of an index pair corresponding to the item.

The importance of each index needs to be scored now because neighboring similarity matrices are used. It is assumed that the training set contains n indexes that have been classified into c classes. Calculation on an intra-class similarity Pᵢₙₜᵣₐ and an inter-class similarity Pᵢₙₜₑᵣ is started, which is as follows:

R=Pᵢₙₜᵣₐ/Pᵢₙₜₑᵣ; (1)

where Pᵢₙₜᵣₐ=Σ_{i,j=1}ⁿPᵢⱼ, (i=j) and Pᵢₙₜₑᵣ=Σ_{i,j=1}ⁿPᵢⱼ, (i≠j) have a decisive effect on the importance of the index. A value of the index is replaced with a random noise, to obtain a new data set, and then the new data set is used on the random forest classifier, to obtain a new similarity matrix Pᵢ, which corresponds to Rᵢ. To find a difference between the new similarity and the original similarity, that is, Rᵢ′=R−Rᵢ, all the indexes are subject to the same process. Finally, the difference between similarities is normalized, that is, ISᵢ=Rᵢ′/S. S is a standard deviation of all the indexes {R₁′, . . . Rₙ′}.

A higher score of the importance of an index indicates a higher correlation of the index to the classifier. Therefore, some indexes that can be used to display data changes (such as changes in wireless network resources) and have relatively high scores may be selected. In fact, it is worth pointing out that, a wireless network has thousands of indexes, and it may take a relatively long time to quantitatively score correlations of all the indexes. To speed up searching, a series of candidate indexes are selected in advance by using knowledge in the art, without searching throughout all the indexes.

Main implementation steps of the PMFS algorithm are specifically shown as follows (a decision-making tree on which training has been finished and which has T nodes).

```
Input: training data of pre-selected indexes
Output: score of importance ISᵢ of each index ft
//Update P
For i = 1:T do
    Acquire a characteristic set of nodes on the tree
    For each pair of indexes fⱼ and fₖ in the
characteristic
    Pⱼₖ=Pⱼₖ+1
    End for
End for
    Normalize P
    Calculate a similarity ratio R based on P by using
formula (1)
    For i = 1:n
        Replace fᵢ with a noise;
        Calculate a similarity ratio Rᵢ:
        Rᵢ=R/Rᵢ
    End for
    Calculate a standard deviation S of :{ Rᵢ\grave{ } ..., Rₙ\grave{ }}
    // Score the importance
    For i = 1:n do
        ISᵢ=Rᵢ/S
    End for
```

According to related index information extracted from the collected data, a regression technology used to obtain the two-layer mapping relationship is analyzed. A sliding window based on adaptive SW-LOESS is developed, which improves execution efficiency of the LOESS, that is, an optimal window size is automatically calculated in a regression process instead of setting a fixed size for the window in an original LOESS algorithm. Specifically, in this algorithm, selected indexes are used as feature items, and values of these feature items are packed into different windows; and meanwhile, window sizes are dynamically adjusted according to distribution and local settings of the windows. In fact, these windows may be set by experts in the art according to their own experience. After the windows are configured, if a feature item with n points and K windows each having the same length (that is, L=n/k) is given, an initial window size is set to

$$\frac{n}{100} ,$$

and a scatterplot is drawn for all measured values sorted in ascending order. It is assumed that f(x), (x=1, . . . , n) represents a function of the scatterplot. First of all, a distribution density of each window is calculated from all function values within a range of the scatterplot in the formula below:

Fⱼ=∫_{f}_{^{−1}}_{(L*j)}^{f}^{^{−1}}^{(L*j+L)}f(x)dx,(j=0, . . . ,k−1)

then, F={F₀, . . . , Fₖ₋₁} is sorted in ascending order, assuming that B_{Fmin} represents a window corresponding to a minimum value in F, B_{Fmed} represents a window corresponding to a mean value in F, and B_{Fmax} represents a window corresponding to a maximum value in F; and the window sizes are dynamically calculated according to a sorting result in the formula below:

$${win}_{—} size = \{ \begin{matrix}\frac{0.5 ( 1 + 1 \text{/} i ) * B}{100} * N , ( B = 0 , … , i ) \\ \frac{1 + ( B - i )}{100} * N , ( B = i + 1 , i + 2 , … , k )\end{matrix}$$

after that, a dynamically LOESS regression algorithm is used for selected feature items at two layers. The mappings at the two layers are successfully obtained after the regression, so that a model of the network traffic can be built by using behavior index information of the mobile App, and a model of cell network resources is further built by using the network traffic, that is, a model for utilization of the cell network resources can be built based on the index information of the mobile App.

In addition, a model that can successfully map behavior characteristic index information at the mobile App level to usage of bottom-layer network resources is developed. In this part, in order to predict mobile App behaviors in the future (to predict utilization of network resources in the future), an already built model is used to design a temporary mining algorithm. In AppToR, characteristic index information of the App is collected from a lot of mobile users and from almost every cell. For example, a time series (between time T1 and time T2) of one behavior index X, such as the throughput or the number of online users of the App, in each cell may be expressed as X(T1), X(T1+1), . . . , X(T2). However, these directly measured data series include various feature item information, such as trend, seasonality, burstiness, volatility, and signal noise. To clearly illustrate how each index changes as time goes by, an algorithm is designed, in which the measured time series is decomposed according to four feature items: (1) trend T(t), which represents a long-term change of the mobile App behavior, such as a user behavior, a charging policy, or the number of users, and reflects a change at a large granularity (for example, per week); (2) seasonality S(T), which represents a periodic change, such as a daily change (busy hours/non-busy hours) of an App flow; (3) burstiness B(t), which represents a significant change caused by a known or an unknown external factor to a normal trend; and (4) random signal noise R(t), which includes an unpredictable fluctuation and a measurable noise. Such decomposition is analysis specifically conducted for operating activities, while these activities usually have a strong seasonal characteristic. In addition to common decomposition methods such as Holt-Winters, an additional feature item is introduced, which is especially suitable when a large flow burst such as the US Super Bowl (which is an American football game) occurs. A component extraction algorithm is analyzed in detail as follows:

1) Extraction of a trend characteristic: To extract the trend characteristic from a time series, the time series is first segmented, and a linear regression algorithm is applied to each segment; and finally, fitting is performed on all segments meeting a requirement, thus expressing a trend of the input time series.

When the time series is segmented, the length of each segment relies on duration for which prediction needs to be performed, that is, a longer prediction time requires a longer segment length. After the segmentation, abnormalities need to be deleted so as to ensure a smooth trend. Therefore, a Shapiro-Wilk test is used first to test the normality of the time series. If the time series conforms to a normal distribution, only remaining value points at two sides out of a 95% confidence level need to be deleted, so as to remove abnormal values. If the time series does not conform to the normal distribution, an inter-quartile range (IQR) is used to eliminate abnormal values. After de-noising, the linear regression algorithm is used to fit these segments.

2) Extraction of a seasonal characteristic: As is known to all, the wireless flow or resource consumption generally is highly cyclical weekly or monthly, and this further enhances the high correlation, such as seasonality, of data in different periods. These fixed lengths are used to extract seasonal characteristic information of the time series, where the seasonal characteristic information can be obtained by using various methods, such as a moving average method.

3) Extraction of a burst characteristic: the burst characteristic represents a significant change caused by a known or an unknown external factor to a normal trend. A known cause is predictable, for example, holidays, while an unpredictable unknown cause is a result of a small-probability random event. For example, many users make calls in a short period of time, causing a tremendous data flow.

A threshold is used to determine whether a burst change occurs. In this model, the burst is defined as a value measured when traffic of a suspicious App exceeds a predetermined data flow threshold. For example, in a normal distribution, data points at two sides lower than a confidence level can be considered as burst points. A more effective method for determining a burst is to compare a value of a point with a value of a normal trend feature item. If a value of a point exceeds the threshold by a predetermined proportion, for example, 120%, it can be determined that the value of this point is a burst point. By using this burst recognition mechanism, for any given cell in different regions, a similar distance may be determined first for an event that may generate a burst flow, for example, a holiday or a sports event. Then, a corresponding burst value and duration are configured for each recognized event. After the known burst points are determined, next, it is observed whether these burst points frequently appear as expected as time goes by. If yes, it can be confirmed that these burst points appear frequently; otherwise, the burst points are taken as a special case (that is, a random signal noise, which will be described below).

4) Extraction of a random signal noise: a random component R(t) may be further decomposed into a stationary time series RS(T) and a white noise RN(T). A measured value of the App characteristic index item minus a sum of measured values of the previous three indexes is an estimated value of the random error. A value of a busy-time random error component is determined by a busy-time average value.

The feasibility of the present invention is proved in the following with reference to experimental results:

The first step lasts for two months: from January 2014 to February 2014. The amounts of download data were collected from 50 intelligent terminals, where these terminals use an Android 4.2+ system compatible with all major Apps (such as facebook, YouTube, LINE, What's app, and GoogleMap). In the present invention, all required App behavior index information is recorded in a form of a log, and test logs are generated and periodically uploaded to this experimental data center. To make sure that the collected App behaviors are consistent with network usage data, four test cells neighboring to each other are deployed. One IMEI list is configured as follows: only the specified intelligent terminals are allowed to access the test cell, while access or handover of any other device to the test cell will be blocked. After these configurations, it can be ensured that App data generated by the 50 intelligent terminals and flow statistics data logs generated in these test cells are completely synchronized online. The second step lasts for seven months, from February 2014 to July 2014. In order to obtain a temporary trend and seasonal information of data, the second step costs a longer time than the first step. In this step, to test, in an actual cell, the model built by the present study group, the test cells are not used. Instead, a DPI is used to collect data in an actual cell for 30 minutes per week. DPI data obtained by means of measurement consists of behavior index information of various Apps, and conform to the granularity of the flow statistics log.

A downlink cell link exchange power (TCP power) is used as an interesting network resource index because the network resource index is a most critical resource for supporting major network functions. Then, in the present experiment, how the mobile App consumes the TCP power is analyzed.

During the experiment, two types of data sets are collected. The first type of data set includes collected logs of Apps and network resource utilization statistical data from test cells in the present invention. The second type of data set is DPI logs. In a word, 207 pieces of data about busy-time network usage are carefully observed, and the data is collected. Data in last 10 hours is eliminated due to incomplete logs, parsing failures, or the like, and 197 pieces of effective busy-time measurement data are obtained; these data can be used to test the designed model and verify the prediction algorithm.

First of all, a discriminative flow index highly correlated to the TCP power is selected by means of the PMFS, and then the PMFS is applied to select an App behavior index highly correlated to the previously selected flow index. According to the 3GPP TR 36.942, the TCP power is first classified into four classes: [0 dBm, 10 dBm], [10 dBm, 20 dBm], [20 dBm, 30 dBm], and [30 dBm, 43 dBm], and each class is marked. A random forest classifier is applied to train 1500 trees, so as to derive a similarity matrix for the TCP power and score the importance of the TCP power. After quantification, data in Table 1 represents top 11 flow indexes highly correlated to the TCP power.

As shown in Table 1, the selected flow indexes can be generally classified into the following three classes:

User-plane index:DL.Cell.Simultaneous.Users.Average,

DL.Cell.PRB.Used.Average,DL.Cell.PDCP.Throughput,Cell.RRC.Connected.Users.Average.

Signaling-plane index:Cell.RRC.Connection.Req,

Cell.PDCCH.OFDM.Symbol.Number,Cell.Paging.UUInterface.Number,Cell.PDCCH.OFDM.CCE.

Number.

Mobility index:Cell.Intra+IntereNB.Handover.In,

Cell.Intra+IntereNB.Handover.Out,

TABLE 1
Selected flow indexes

| | Score of |
|---|---|
| Flow index | importance |
| DL.Cell.PRB.Used.Average | 0.8735 |
| DL.Cell.Simultaneous.Users.Average | 0.8454 |
| DL.Cell.PDCP.Throughput | 0.8253 |
| Cell.RRC.Connected.Users.Average | 0.8192 |
| Cell.RRC.Connection.Req | 0.7960 |
| Cell.eRAB.Setup.Req | 0.7807 |
| Cell.Paging.UUInterface.Number | 0.7402 |
| Cell.PDCCH.OFDM.Symbol.Number | 0.7396 |
| Cell.PDCCH.OFDM.CCE.Number | 0.7308 |
| Cell.Intra + IntereNB.Handover.Out | 0.6377 |
| Cell.Intra + IntereNB.Handover.In | 0.6169 |

These two are an ingress direction and an egress direction of an intra-eNodeB/inter-eNodeB handover. The selected indexes and the classes corresponding to the selected indexes are as expected because the three classes are major factors that cause great consumption of wireless network resources. Similarly, App behavior indexes are selected according to the selected flow indexes and by means of the PMFS. Data in Table 2 lists the top 13 App indexes that have relatively great influence on the flow indexes.

TABLE 2
Selected App behavior indexes

| | Score of |
|---|---|
| App behavior index | importance |
| DL.TrafficVolumn.Bytes.PerApp | 0.8690 |
| DL.MeanHoldingTime.PerSession.PerApp | 0.8529 |
| Sessions.PerUser.PerApp | 0.8181 |
| ActiveSessions.PerApp | 0.8116 |
| Registered.Users.PerApp | 0.8012 |
| DL.ActiveUsers.PerApp | 0.7921 |
| Throughput.PerSession.PerApp | 0.7408 |
| DL.PacketCall.Frequency.PerApp | 0.7134 |
| UL.ActiveUsers.PerApp | 0.7103 |
| DL.Bytes.PerPacketCall.PerApp | 0.6945 |
| DL.Packets.PerPacketCall.PerApp | 0.6733 |
| PacketFreq.PerPacketCall.PerApp | 0.6402 |
| DL.PacketCalls.PerSession.PerApp | 0.6307 |

To estimate the accuracy of the two-layer mapping model, 80% of the whole data set is used as a training set, 20% of the whole data set is used as a test set, and the designed SW-LOESS regression algorithm is applied. Index data calculated according to the model of the present invention is compared with measured values of an actual region, and an error of the model built this time is calculated by using a mean absolute percentage error (MAPE) in the formula below:

$$e = \frac{1}{n} {\sum }_{i = 1}^{n} \vert \frac{{S}_{i}^{measure} - {S}_{i}^{est}}{{S}_{i}^{measure}} \vert ,$$

where Sᵢ^{measure} and Sᵢ^{est} respectively correspond to a measurable index and an estimated index of the i^{th} App, and MAPE values of the 11 selected flow indexes are already listed in FIG. 2. It is shown according to the data in FIG. 2 that, except the index related to the mobility, it can be observed that MAPE measured values of all the flow indexes are less than 0.25, and MAPE training values thereof are smaller. The value of the mobility index is relatively high because data used in the model built in the present study is data in the four test cells, while data used in many widely distributed cells are DPI data. Obtained mobile behavior index data is insufficient because the test cells are neighboring to each other, and therefore, the MAPE value of the mobility-related index is higher than others. However, the score of importance of the mobility index is relatively low (see Table 1, where the score is less than 0.65), and the influence from the MAPE value thereof on the accuracy of the model is not large. Hundreds of mobile Apps are configured, and data in FIG. 3 represents utilization, expressed in percentages, of network resources (the TCP power) by major Apps.

HTTP/HTTPS, for example, a browser, has the highest resource consumption, because a Web browser is always used most frequently among Apps on the intelligent terminal. Streaming media Apps, such as P2P, Netflix, and related video files, also have relatively high resource consumption. In addition to these two types of Apps, Apps that send commands frequently, such as facebook and What's app, consume considerable network resources because they have a lot of users. These analyses help mobile operators understand how wireless network resources used by each mobile App are consumed, and are very helpful for resource management and pricing by the mobile operators.

The designed prediction algorithm based on a time series is used to predict a behavior index of an App. Results of two typical application indexes are predicted: the number of offline users and the number of online active users. The prediction results are: MAPE training values of the two indexes are 7.47% and 8.93% respectively, while MAPE predicted (test) values thereof increase slightly, reaching 12.54% and 13.39% respectively. A difference between the MAPE of a training set and the MAPE of a prediction set is about 5%, which is relatively low, and the data verifies that the present prediction model is reliable and robust. Meanwhile, this prediction algorithm is also applied to other indexes, and an MAPE value range during training of these indexes is between 7.47% and 18.34%, and an MAPE value range during prediction is between 12.54% and 25.78%. In a word, the predicted MAPE values of most indexes are less than 15%. A maximum MAPE value in prediction is the MAPE value of DL.PacketCalls.PerSession.PerApp, which is caused by unstable App combinations in the cell during a sampling time. For example, most of a data flow in a cell is generated by YouTube after a period of time, and after that, all flow is switched to instant messaging. Such a drastic change in App combination causes a significant change of a certain index, which makes it difficult for the index to reflect the long-term trend, and the mid-term and short-term seasonal characteristics. On the other hand, this study also explains why a certain index has a lowest score of importance in Table 2 in the mapping model of the present invention.

In conclusion, in the present invention, a two-layer mapping model is first established among behavior characteristic indexes of a mobile app, wireless network resources, and network traffic, to analyze utilization of network resources by the mobile App. Meanwhile, a crowdsourcing-based wireless network analysis system named AppToR is developed, where the system can collect behavior data of various types of Apps from mobile users. In addition, a group of algorithms that can extract related characteristic information from the collected data are also provided, and regression is performed on these characteristic indexes, so as to establish a relational mapping model. Finally, the present invention is deployed in an LTE-dominant wireless network, and experiment and observation are carried out to estimate the performance thereof. The experiment proves that the present invention is highly accurate in estimating and predicting utilization of cell wireless network resources by mobile Apps.

The above description only provides preferred embodiments of the present invention, but is not intended to limit the present invention. Although the present invention has been described in detail with reference to the embodiments above, persons skilled in the art can still make modifications to the technical solutions described in the embodiments above, or make equivalent replacements to some of technical features. Any modification, equivalent replacement, or improvement made without departing from the spirit and principle of the present invention shall fall within the scope of the present invention.

1. A crowdsourcing-mode-based analysis method for utilization of wireless network resources by mobile applications (Apps), comprising: collecting behavior indexes of a mobile App by using a crowdsourcing tool and an analysis algorithm that is located on a server, and performing data mining on the behavior indexes; and establishing a mapping model among behavior characteristic indexes of the mobile App, wireless network resources, and network traffic, and analyzing utilization of the network resources by the mobile App.

2. The crowdsourcing-mode-based analysis method for utilization of wireless network resources by mobile Apps according to claim 1, wherein the mapping model is a two-layer causality mapping model, which is a quantifiable mapping established between the mobile App and the network traffic by selecting related indexes as feature items and as a regression basis.

3. The crowdsourcing-mode-based analysis method for utilization of wireless network resources by mobile Apps according to claim 2, wherein the two-layer causality mapping model is specifically established in the following manner: designing a similarity matrix-assisted feature selection algorithm that is based on a random forest decision tree, selecting a mobile App performance characteristic index highly correlated to network traffic, developing a sliding-window-based locally weighted scatterplot smoothing algorithm, and establishing a two-layer mapping by performing regression on the selected indexes, where the two-layer mapping includes a mapping between the mobile App and the network traffic, and a mapping between the network traffic and the network resources, that is, a behavioral change of the mobile App can be used to build a model of a lower-layer network traffic change, and the network traffic is further used to build a model of the network resources.

4. The crowdsourcing-mode-based analysis method for utilization of wireless network resources by mobile Apps according to claim 2, wherein it is assumed that the similarity matrix is P, and P is an n*n all-zero matrix; for a node of a tree, it is assumed that there are two indexes, which are recorded as fᵢ and fⱼ respectively, then an item Pᵢⱼ in the matrix is modified to be a value obtained by adding Pᵢⱼ by 1: Pᵢⱼ=Pᵢⱼ+1, and this process is repeated until all decision trees are generated; a value of each item in the matrix is normalized or quantified, wherein each item represents a similarity of an index pair corresponding to the item.

5. The crowdsourcing-mode-based analysis method for utilization of wireless network resources by mobile Apps according to claim 3, wherein the sliding-window-based locally weighted scatterplot smoothing algorithm is specifically established in the following manner: using selected indexes as feature items, distributing values of the feature items into corresponding window intervals, and dynamically adjusting window sizes according to distribution and local settings of windows.

6. The crowdsourcing-mode-based analysis method for utilization of wireless network resources by mobile Apps according to claim 5, wherein after the windows are configured, a feature item with n points and K windows each having the same length (that is, L=n/k) is given, an initial window size is set to n/100, and a scatterplot is drawn for all measured values sorted in ascending order; it is assumed that f(x), (x=1, n) represents a function of the scatterplot; first of all, a distribution density of each window is calculated from all function values within a range of the scatterplot in the formula below:
Fⱼ=∫_{f}_{^{−1}}_{(L*j)}^{f}^{^{−1}}^{(L*j+L)}f(x)dx,(j=0, . . . ,k−1)
then, F={F₀, . . . , Fₖ₋₁} is sorted in ascending order, assuming that B_{Fmin} represents a window corresponding to a minimum value in F, B_{Fmed} represents a window corresponding to a mean value in F, and B_{Fmax} represents a window corresponding to a maximum value in F; and the window sizes are dynamically calculated according to a sorting result in the formula below:
$${win}_{—} size = \{ \begin{matrix}\frac{0.5 ( 1 + 1 \text{/} i ) * B}{100} * N , ( B = 0 , … , i ) \\ \frac{1 + ( B - i )}{100} * N , ( B = i + 1 , i + 2 , … , k )\end{matrix}$$
after that, a dynamically LOESS regression algorithm is performed on selected feature items at two layers, and the mappings at the two layers are successfully obtained after the regression; behavior characteristic index information of the mobile App is used to build a model of the network traffic, and the network traffic is further used to build a model of the network resources, that is, a model for cell-plane-based utilization of cell network resources by the mobile service App is built.

7. The crowdsourcing-mode-based analysis method for utilization of wireless network resources by mobile Apps according to claim 3, wherein it is assumed that the similarity matrix is P, and P is an n*n all-zero matrix; for a node of a tree, it is assumed that there are two indexes, which are recorded as fᵢ and fⱼ respectively, then an item Pᵢⱼ in the matrix is modified to be a value obtained by adding Pᵢⱼ by 1: Pᵢⱼ=Pᵢⱼ+1, and this process is repeated until all decision trees are generated; a value of each item in the matrix is normalized or quantified, wherein each item represents a similarity of an index pair corresponding to the item.
